(19) United States
(12) Patent Application Publication
(10) Pub. No.: US 2012/0322638 A1
(43) Pub. Date: Dec. 20, 2012

(54) METHOD FOR FORMING THEFT-RESISTANT PRODUCT PACKAGING

(75) Inventors: Brett P. Seber, Vista, CA (US); James S. Gleason, Yorba Linda, CA (US); Randolph J. Morton, El Cajon, CA (US)

(73) Assignee: SEBERCOR LLC, Vista, CA (US)

(21) Appl. No.: 13/523,544

(22) Filed: Jun. 14, 2012

Related U.S. Application Data
(60) Provisional application No. 61/497,789, filed on Jun. 16, 2011.

(51) Int. Cl. B31B 7/00

(52) U.S. Cl. 493/110

(57) ABSTRACT

A method for manufacturing theft-resistant product packaging includes the steps of (1) providing a matrix of cut-resistant strands, (2) adhering the matrix to a plastic substrate to form a theft-resistant material, (3) forming a front shell from the theft-resistant material including a cavity for holding a product therein, and (4) securing the front shell to a back cover so as to enclose the product therebetween.

### FIELD OF THE INVENTION

The present invention generally relates to packaging. More particularly, the present invention relates to tamper resistant product packaging.

### BACKGROUND OF THE INVENTION

Product packaging is the science, art, and technology of enclosing or protecting products for distribution, storage, sale, and use. Product packaging can be described as a coordinated system of preparing goods for transport, warehousing, logistics, sale, and end use. Product packaging contains, protects, preserves, transports, informs, and helps sell the product it contains.

The first product packages used the natural materials available at the time including baskets of reeds, wooden boxes, pottery vases, ceramic amphorae, wooden barrels, and woven bags. Processed materials were used to form packages as they were developed. For example, early glass and bronze vessels. The earliest recorded use of paper for packaging dates back to 1035, when a Persian traveler visiting markets in Cairo noted that vegetables, spices and hardware were wrapped in paper for the customers after they were sold. Iron and tin plated steel were used to make cans in the early 19th century. Paperboard cartons and corrugated fiberboard boxes were first introduced in the late 19th century. Product packaging advancements in the early 20th century included Bakelite closures on bottles, transparent cellophane overwraps and panels on cartons, increased processing efficiency and improved food safety. As additional materials such as aluminum and several types of plastic were developed, they were incorporated into packages to improve performance and functionality. In-plant recycling has long been common for production of packaging materials. Now post-consumer recycling of aluminum and paper based products has been economical for many years. Since the 1980s, post-consumer recycling has increased due to curbside recycling, consumer awareness, and regulatory pressure.

As of 2003, the packaging sector accounted for about two percent of the gross national product in developed countries. About half of this market was related to food packaging. Product packaging serves a multitude of purposes today. First, product packaging is physical protection as the objects enclosed in the package may require protection from, among other things, mechanical shock, vibration, electrostatic discharge, compression, and temperature. Second, product packaging may provide a barrier protection from oxygen, water vapor, and dust. Permeation is a critical factor in design. Some packages contain desiccants or oxygen absorbers to help extend shelf life. Modified atmospheres or controlled atmospheres are also maintained in some food packages. Keeping the contents clean, fresh, sterile and safe for the intended shelf life is a primary function. Product packaging may also aid in containment or agglomeration when small objects are typically grouped together in one package for reasons of efficiency. For example, a single box of 1000 pencils requires less physical handling than 1000 single pencils. Liquids, powders, and granular materials also need containment. Product packaging is also used for information transmission as packages and labels communicate how to use, transport, recycle, or dispose of the package or product. With pharmaceuticals, food, medical, and chemical products, some types of information are required by governments. Some packages and labels also are used for track and trace purposes. Product packaging is used for marketing as the packaging and labels can be used by marketers to encourage potential buyers to purchase the product. Product package graphic design and physical design have been important and constantly evolving phenomenon for several decades. Marketing communications and graphic design are applied to the surface of the package and (in many cases) the point of sale display. Product packaging is also for convenience as packages can have features that add convenience in distribution, handling, stacking, display, sale, opening, reclosing, use, dispensing, and reuse. Also, product packaging can be used for portion control as a single serving or single dosage packaging has a precise amount of contents to control usage. Bulk commodities (such as salt) can be divided into packages that are a more suitable size for individual households and also aids the control of inventory.

One function of product packaging that most people don't realize is for security. Product packaging can play an important role in reducing the security risks of shipment. Packages can be made with improved tamper resistance to deter tampering and also can have tamper-evident features to help indicate tampering. Packages can be engineered to help reduce the risks of package pilferage. Some package constructions are more resistant to pilferage and some have pilfer-indicating seals. Packages may include authentication seals and use security printing to help indicate that the package and contents are not counterfeit. Packages also can include anti-theft devices, such as dye-packs, RFID tags, or electronic article surveillance tags that can be activated or detected by devices at exit points and require specialized tools to deactivate. Using product packaging in this way is a means of loss prevention.

Unfortunately, theft of goods is quite prominent today despite the advances in product packaging and theft prevention techniques. Two particular packaging types are quite susceptible to theft; the clamshell and blister pack product packaging. Clamshells are generally comprised of a housing and a chamber for storing products and may be reusable or permanently sealed. Permanently sealed clamshells are generally formed from a clear plastic housing that is sealed together through radio frequency (RF), sonic vibrations or electrical resistance. As the housing is generally made from clear plastic, inserts made of cardboard and other materials are often inserted into the clamshell packaging to describe or label the goods. Blister packs typically have two layers of cardboard or stiff paper with a clear plastic housing on the other side. Between the clear plastic housing and the cardboard is the product.

Many clamshell and blister packs have RFID tags embedded in the housing such that it is difficult to carry the product with the packaging out through the sensors at the entrance and exit of a storefront. Therefore, the thieves have simply removed the product from the packaging while still in the store. For instance, an area of high theft is in the knives department. With some retailers, they report to have stolen four knives for every one they legitimately sell. The thieves will grab the product off the shelves, relocate to a less noticeable spot and simply cut open the package to the remove the product. The thieves will literally use a knife, razor blade, or other cutting tool to slice open the clamshell and blister pack and then remove the product.

To help deter pilfering, the clamshell thickness has increased to make it harder to penetrate. This also means the cost of the product packaging itself has gone up and the overall product is now more costly. The cost of the thicker product packaging and the stolen product is passed on to the consumer. Additionally, such thick plastic packaging is typically slippery, whereby a knife being used to open the package by penetrating the plastic clamshell can bounce or slip off the package and cut or otherwise wound the user. Many stores want to reduce the amount of wasted material in their product packaging, yet want to prevent or reduce the amount of pilfered goods. Rising oil prices also drives the cost of plastic packaging up.

Accordingly, there is a need for a clamshell and blister pack design that reduces or eliminates the ability of a thief to quickly and easily slice open the product packaging to then steal the product located inside. The present invention fulfills these needs and provides other related advantages.

### SUMMARY OF THE INVENTION

The present invention is directed to theft-resistant product packaging. The packaging comprises a front shell and a back cover secured to one another by folding, bonding, gluing and/or stapling edges of the cover shell and backing shell together. The front shell comprises a matrix of cut-resistant strands disposed within or adjacent to a plastic substrate. The cover shell may be preformed with a recess conforming to a shape of the product.

The back cover is disposed relative to the front shell so as to form a cavity configured to contain a product. The back cover comprises cardboard, wood, metal, plastic or a matrix of cut-resistant strands disposed within or adjacent to a plastic substrate.

The cut-resistant strands may comprise metal, fiber or fabric and include a hard, outer shell comprising a hardened adhesive, a powdered metal, or a ceramic material. The matrix may comprise a grid of cut-resistant strands overlayed, weaved, or twisted with respect to intersecting strands. The cut-resistant strands are disposed in the grid so as to form squares, rectangles, diamonds or parallelograms. The intersecting strands are welded, glued or bound at the points of intersection.

The plastic substrate may comprise a laminate of thermoplastic or bio-film material formed around the matrix. The plastic substrate comprises first and second laminates of thermoplastic or bio-film material disposed on opposite sides of the matrix and formed around the matrix.

A method for manufacturing the theft-resistant product packaging comprises the step of providing a matrix of cut-resistant strands. The matrix is adhered to a plastic substrate to form a theft-resistant material. A front shell is formed from the theft-resistant material and includes a cavity for holding a product therein. The front shell is secured to a back cover so as to enclose the product therebetween.

The providing step includes orienting a first set of individual strands in a first direction and orienting a second set of individual strands in a second direction different from the first direction. A matrix is formed by overlaying, weaving, wefting and warping and warping, or twisting the first and second sets of strands together. The first and second sets of wires are secured, welded, glued or bonded together. The first and second directions of the first and second sets of wires may be oriented perpendicularly to each other.

The method may also comprise the step of coating the strands with a hard, outer shell comprising a hardened adhesive, a powdered metal, or a ceramic material. The adhesive is initially applied as a liquid or other soft form and is hardened by the end of the process. The adhering step may include the steps of applying a first laminate of thermoplastic or bio-film material to one side of the matrix, and heating the matrix and first laminate such that the first laminate softens such that it becomes pliable. The applying step may include applying a second laminate of thermoplastic or bio-film material to another side of the matrix. Once heated the matrix and first/second laminate(s) are pressed such that the first/second laminate(s) becomes formed around and bonded to the matrix. The matrix and first/second laminate(s) may also be cooled to fix the matrix and first/second laminate(s) together.

The adhering step includes the steps of pulling the matrix across a surface, dispensing small pieces of thermoplastic or bio-film material over the matrix on the surface, heating the small pieces such that they soften or melt around the matrix, and rolling the matrix and heated small pieces such that they form the plastic substrate around the matrix. As above, the matrix and plastic substrate may be cooled to fix the matrix and plastic substrate together.

The forming step includes the steps of shaping the theft-resistant material into a clam shell or blister pack, and preforming a recess in the front shell conformed to a shape of the product. The forming step also includes the step of forming an unobstructed area in the front shell that is devoid of the matrix. The back cover comprises cardboard, wood, metal, plastic or theft-resistant material. The securing step comprises folding, bonding, gluing and/or stapling edges of the front shell and back cover together.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a simplified perspective view of an exemplary manufacturing process of the present invention;

FIG. 2A is a simplified perspective view of a portion of an exemplary manufacturing process of the present invention continued from FIG. 1;

FIG. 2B is a simplified perspective view of a portion of an alternate exemplary manufacturing process of the present invention continued from FIG. 1;

FIG. 3 is a simplified perspective view of a portion of an exemplary manufacturing process of the present invention continued from either FIG. 2A or 2B;

FIG. 4 is a simplified perspective view of a portion of an alternate exemplary manufacturing process of the present invention;

FIG. 4A is a simplified perspective view of a portion of an alternate exemplary manufacturing process of the present invention;

FIG. 5 is a side view illustration of the structure of FIG. 2A taken along line 5-5;

FIG. 6 is a side view illustration of the structure of FIG. 2B taken along line 6-6;

FIG. 7 is an illustration of the wire grid before and after the processing steps illustrated in FIGS. 2A or 2B;

FIG. 8 is a close-up view of the wire grid of FIG. 7 indicated by circle 8;

FIG. 9 is a top view of an exemplary embodiment of a wire mesh structure;

FIG. 10 is a top view of another exemplary embodiment of a wire mesh structure;

FIG. 11 is an enlarged sectional view of the structure of FIG. 9 indicated by circle 11 showing the wires welded;

FIG. 12 is an enlarged sectional view of the structure of FIG. 9 indicated by circle 12 showing the wires overlapping;

FIG. 13 is an enlarged sectional view of the structure of FIG. 10 indicated by circle 13 showing the wires welded;

FIG. 14 is an enlarged sectional view of the structure of FIG. 10 indicated by circle 14 showing adjacent wires twisted and connected;

FIG. 15 is a simplified perspective view of an exemplary manufacturing process of the present invention;

FIG. 16 is a simplified perspective view of an alternate exemplary manufacturing process of the present invention;

FIG. 17 is a simplified perspective view of another alternate exemplary manufacturing process of the present invention;

FIG. 18 is a sectional view of the manufacturing process of FIG. 15 taken along line 18-18;

FIG. 19 is a sectional view of the exemplary manufacturing process of FIG. 15 taken along line 19-19;

FIG. 20 is a sectional view of the exemplary manufacturing process of FIG. 16 taken along line 20-20;

FIG. 21 is a sectional view of the exemplary manufacturing process of FIG. 16 taken along line 21-21;

FIG. 22 is a sectional view of the exemplary manufacturing process of FIG. 17 taken along line 22-22;

FIG. 23 is a sectional view of the exemplary manufacturing process of FIG. 17 taken along line 23-23;

FIG. 24 is a perspective view of a clam pack embodying the present invention about to package a product;

FIG. 25 is a perspective view of the clam pack of FIG. 24 now packaging a product;

FIG. 26 is a perspective view of a clamshell mold embodying the present invention;

FIG. 27 is a perspective view of a clamshell embodying the present invention before it is folded;

FIG. 28 is a perspective view of the clamshell of FIG. 27 now folded about to package a product;

FIG. 29 is a perspective view of the clamshell of FIG. 27 now packaging a product;

FIG. 30 is a perspective view of the structure of FIG. 29 now resistant to cutting with a knife or razor;

FIG. 31 is a perspective view of a clam pack alternate embodiment of the present invention about to package a product;

FIG. 32 is a perspective view of the clam pack of FIG. 31 now packaging a product;

FIG. 33 is a simplified perspective view of another alternate exemplary manufacturing process of the present invention;

FIG. 34 is a perspective view of a blister pack embodying the present invention about to package a product; and

FIG. 35 is a perspective view of the blister pack of FIG. 34 now packaging a product.

### DETAILED DESCRIPTION OF THE PREFERRED EMBODIMENTS

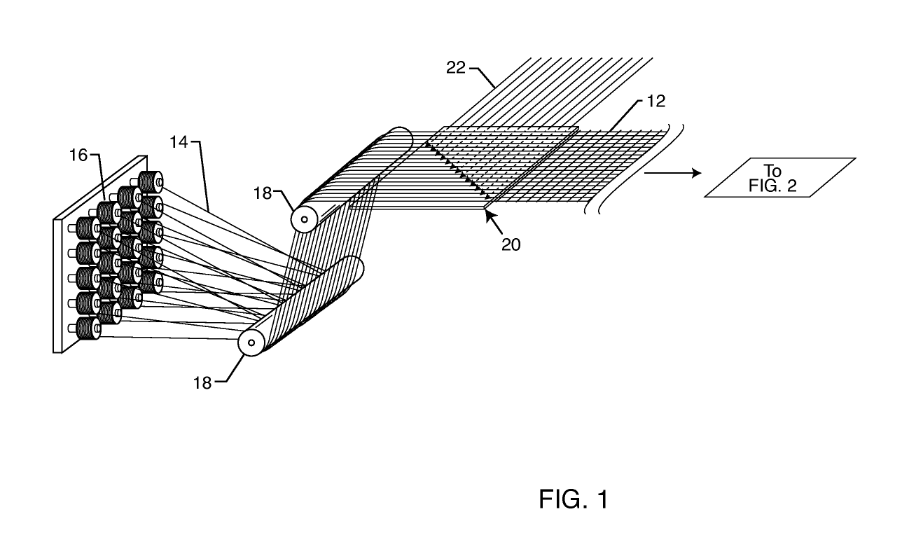

FIGS. 1-3 present simplified perspective views of an exemplary manufacturing process 10 for theft proof product packaging of the present invention. In FIG. 1, a wire grid or two-dimensional matrix 12 is formed first. The wire grid 12 is formed from a plurality of individual cut-resistant wires or strands 14. The individual wires 14 come out of a machine called a creel 16. The creel 16 is able to store the rolls of individual wires 14. The creel 16 organizes the plurality of individual wires 14 into the correct location to thereafter form the wire grid 12. A first set of individual wires 14 come out of the creel 16 and pass through a series of idle rollers 18. The idle rollers 18 help to align the individual wires 14 into their proper spacing.

The individual wires 14 then pass through a weft and warp insertion machine 20. The weft and warp insertion machine 20 introduces a perpendicular set of wires 22 to the previous individual wires 14 to form wire grid 12. The perpendicular wires 22 are fed from a second creel or similar machine (not shown). The weft and warp insertion machine 20 may place a plurality of perpendicular individual wires 22 onto, i.e., overlaying, or weaved within the individual wires 14. The perpendicular wires 22 can be welded, weaved, glued, bound or temporarily held into place in relation to their spacing and position to the individual wires 14. The wires 14 and 22 may comprise metal, fiber, fabric or other cut-resistant material, as described below. The wires 14 and 22 may be coated with an adhesive material to increase cutting resistance. The adhesive material creates a hard shell with fiber or fabric through the core. The wires 14 and 22 may also comprise fiber or fabric coated with a powdered metal or ceramic material to provide a hard outer shell resistant to cutting.

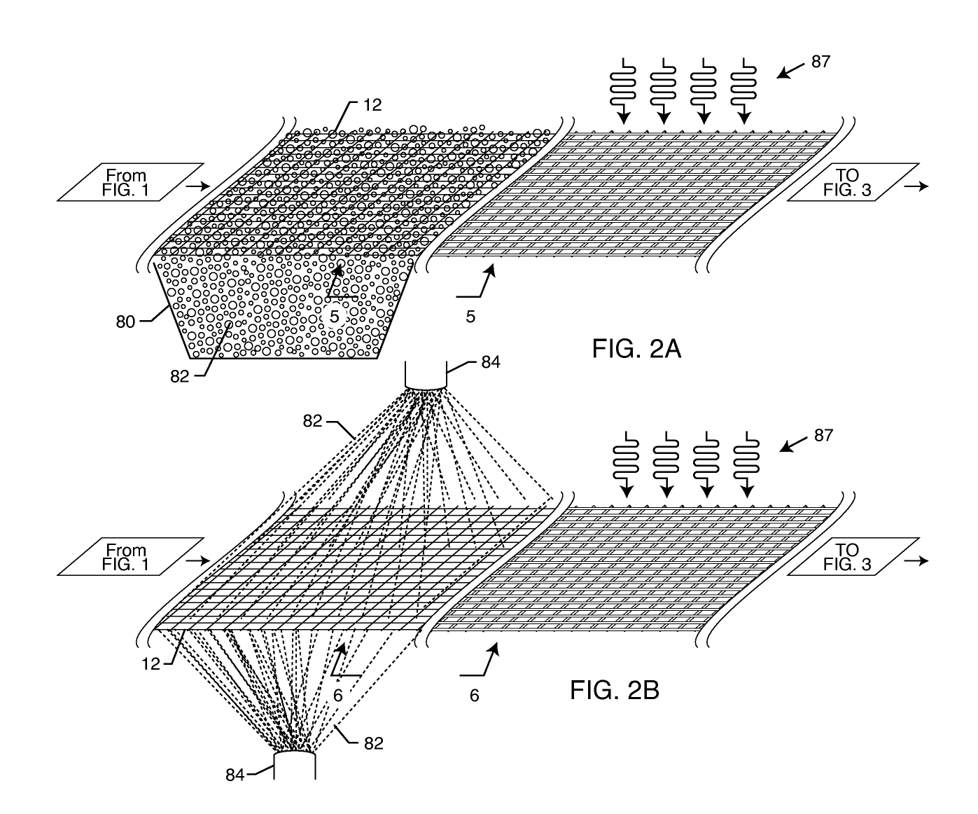

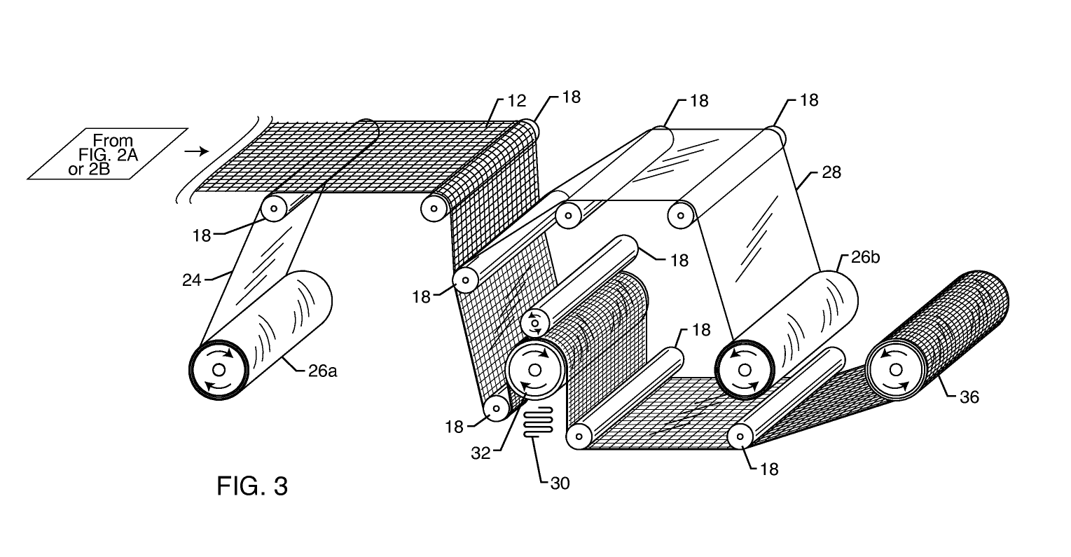

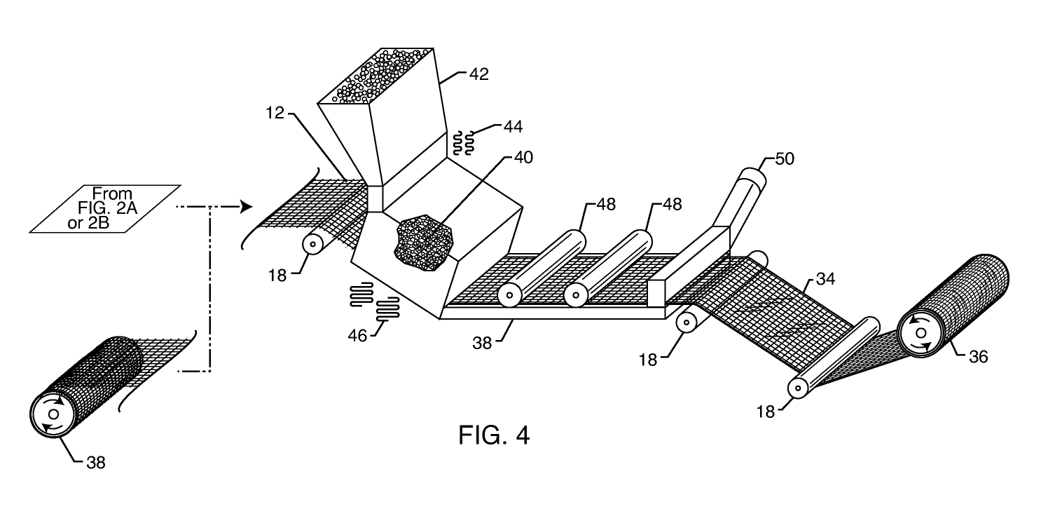

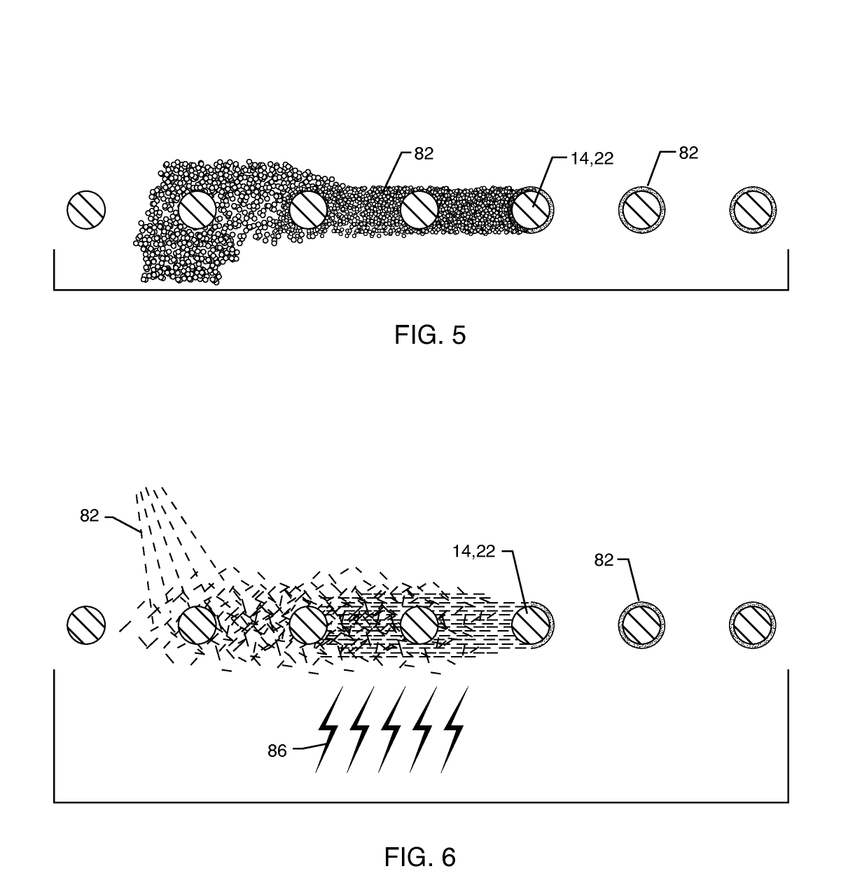

In the next step, illustrated in FIGS. 2A and 2B, the wire grid 12 is subjected to a process that adds an adhesive coating to the wire 14, 22. In FIG. 2A, the wire grid 12 is passed through a vat or bath 80 of liquid or viscous adhesive material 82 that is caused to adhere to the wires 14, 22 by any known process. The adhesive material 82 may comprise a form of polymer which is caused to conform to the wires 14, 22 as by heating or other known process. FIG. 5 illustrates a partial side view of the process applying this adhesive material 82 to wires 22. FIG. 2B illustrates an alternate process for applying the adhesive material 82. In this alternate process, the adhesive material 82 is applied via spray guns 84 either above, below or on both sides of the wire grid 12. In this method of application, the adhesive material 82 may comprise metallic, ceramic or carbon materials that are subjected to an electromagnetic charge 86 as depicted in FIG. 6. It is worth noting that the process for applying the adhesive material 84 to the wires 14, 22 preferably does not involve sintering or a similar process. Both of these adhesive application processes are followed by a heating or curing process 87 to set the adhesive 82 as a hardened coating.

The next step in FIG. 3 is when the wire grid 12 with the adhesive coating 82 is mated on one side to a first laminate 24 from a laminate reel 26a. The wire grid 12 and first laminate 24 meet when they pass over another idle roller 18 or series of idle rollers 18. A second laminate 28 may then be introduced from another laminate reel 26b. The second laminate 28 can pass through a series of idle rollers 18 as it then mates to the wire grid 12. Now, the wire grid 12 has a first laminate 24 on one side and a second laminate 28 on the other side. Alternately, either laminate 24, 28 may be omitted so that the wire grid 12 only has one laminate on one side. This is described more fully below.

A heat process 30 is applied to the wire grid 12, laminate 24 and laminate 28 if present. The heat process 30 can be a multitude of designs and configurations used by one skilled in the art. For example, the heat process 30 can be accomplished through an oven, hot air, radiation, microwave/radio waves or other radiometric means. Here, it is shown simplistically as applied heat to the wire grid and forcing it between an idle roller 18 and a larger heated roller 32. Heat is absorbed into the laminates 24 and 28 which cause them to soften and become pliable so as to form around the wire grid 12 and also bond together. Now the wire grid 12 and laminates 24 and 28 are laminated together to act as a single material of theft proof product packing material 34. The material 34 is then rolled onto a storage reel 36 to be used later to create theft proof product packaging. As can be seen by one skilled in the art, there may exist a multitude of pathways and location of idle rollers 18 that accomplish the same end result, and this disclosure is not limited to the exact configuration shown and described herein.

The laminates 24 and 28 may be made from any common thermoplastic material. Alternatively, the laminates 24 and 28 may be made from a bio-film, such as corn-based material. Where bio-film on its own would tend to lose its shape and integrity in fairly low temperatures—125°-150°—the addition of the wire grid 12 provides a support framework for the bio-film. With this support framework, the bio-film can retain its shape and integrity in higher temperatures.

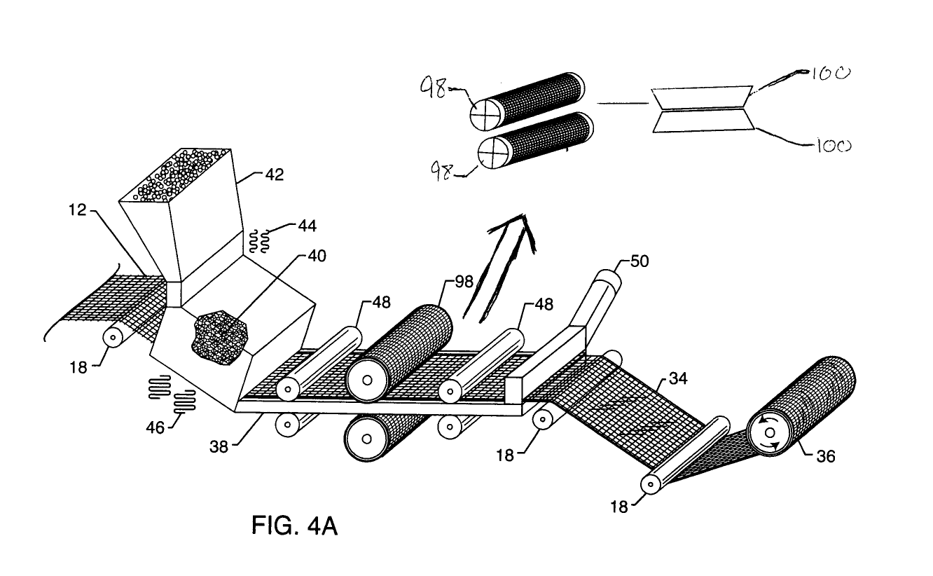

FIG. 4 is another simplified perspective view of an alternate exemplary manufacturing process 10 for theft proof product packaging of the present invention. The wire grid 12 can be formed as was in FIGS. 1, 2A and 2B with the creel 16 and weft and warp insertion 20, or can be taken from a premade wire grid reel 38. The wire grid 12 is pulled onto a surface 38 where plastic feed 40 is combined and heated. The plastic feed 40 is small bits of plastic material. The plastic feed 40 is channeled into a plastic feed shute 42 such that is can be appropriately dispensed over the wire grid 12.

As the plastic feed 40 is in the plastic feed shute 42, it is pre-heated at the pre-heat stage 44. When the plastic feed 40 is dispensed over the wire grid 12, it is further heated in the final heat stage 46. The plastic feed 40 is distributed over and around the wire mesh. The heat 46 melts or softens the plastic feed 40 such that it flows around and bonds to the wire grid 12. The plastic feed 40 and wire grid 12 are then pulled through a blend and cover chamber where the heat is allowed to penetrate the plastic feed 40 as it forms around the wire grid 12. Next, the wire grid 12 and plastic feed 40 go through a series of leveling and thickness rollers 48. The rollers 48 level the amount of plastic in relation to the wire grid 12 such that any inconsistencies are eliminated or reduced.

As illustrated in FIG. 4A, the wire grid 12 and plastic feed 40 may be passed between top and bottom pocket impression rollers 98 designed to compress the plastic feed 40 through the openings on the grid 12. As illustrated in the close up of FIG. 4A, the pocket impression rollers 98 have abutting teeth 99 configured to create waffle-like impressions 100 in the plastic feed 40 that coincide with the shape of the wire grid 12. In this method of manufacture, the pocket impression rollers 98 are necessary to compress the plastic such that the manufactured material 34 is not unnecessarily bulky or heavy by a uniformly thick layer of plastic. At this point the plastic feed 40 has melted or softened and been formed around the wire grid 12 to create the theft proof product packaging material 34. The material 34 is quickly drawn through a cooling chamber 50 to stop any residual melting or movement of the plastic relative to the wire grid 12. The material 34 is then passed through a series of idle rollers 18 as it is rolled onto a storage reel 36. As can be seen by one skilled in the art, the material 34 can be formed by combining one or two laminate sheets 24, 28 with a metal grid 12 or by using a plastic feed 40 which is then melted to the wire grid, as this disclosure is not limited to the precise forms described and shown herein.

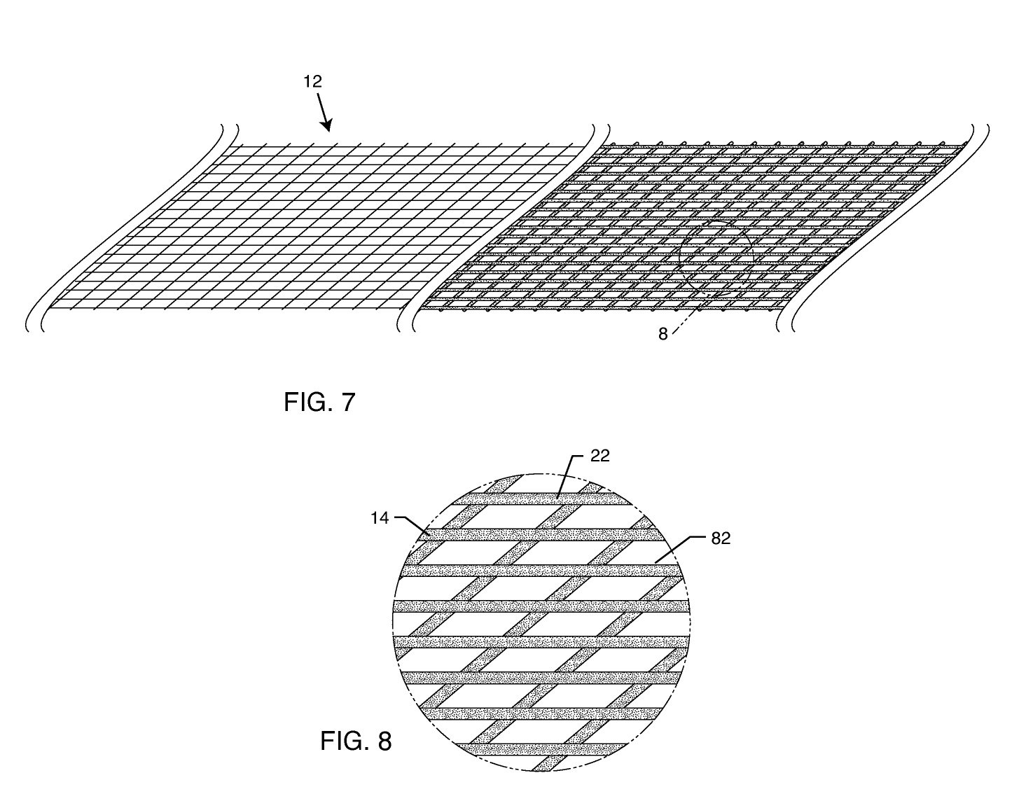

FIG. 7 illustrates the wire grid 12 along different portions of the manufacturing process illustrated in FIGS. 1, 2A and 2B. In particular, the left side of FIG. 7 illustrates the wire grid 12 before the application of the adhesive material 82 in either FIG. 2A or FIG. 2B. The right side of FIG. 7 illustrates the wire grid 12 after application of the adhesive material 82 as illustrated in FIG. 2A or FIG. 2B. FIG. 8 illustrates a close-up view of the wire grid as indicted by circle 8 in FIG. 7. In this close-up view, the adhesive material 82 can be seen encasing each of the wires 14, 22 in the wire grid 12.

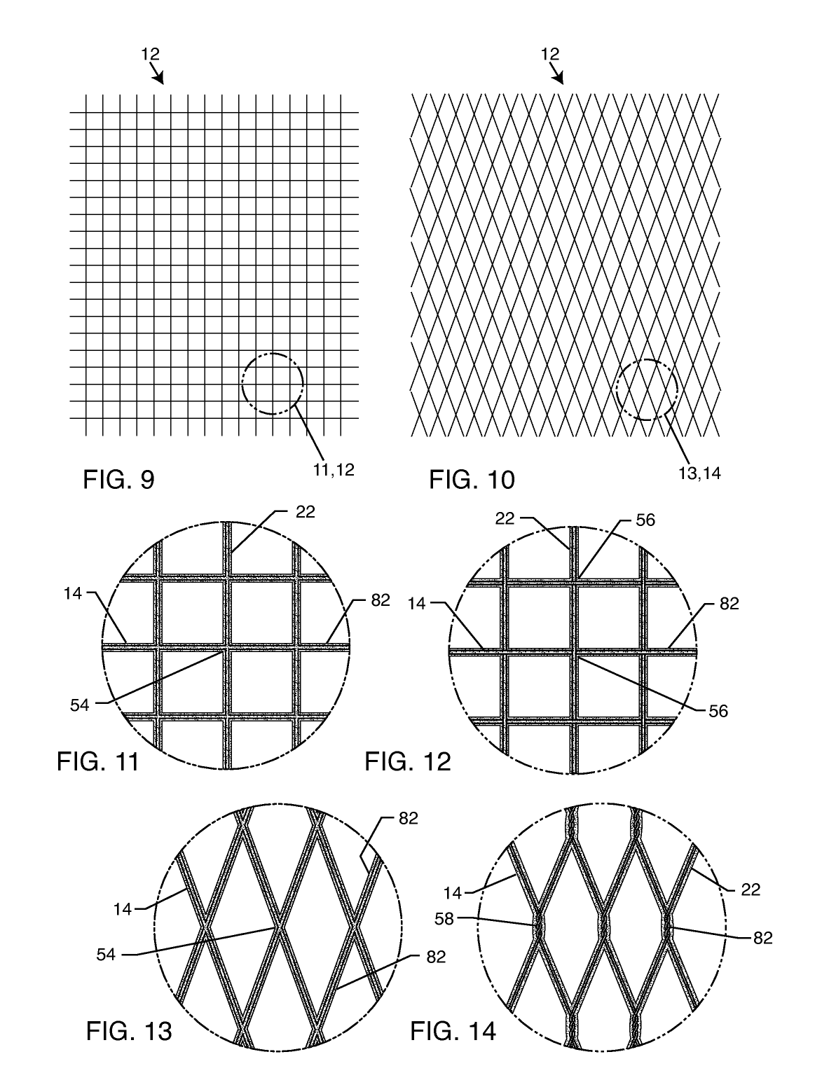

A multitude of different wire grids 12 can be devised by one skilled the art. FIG. 9 is a top view of an exemplary embodiment of a wire mesh structure 12. The wire mesh/grid 12 is made of perpendicular wires, including the individual wires 14 and perpendicular wires 22. FIG. 11 is an enlarged sectional view of the structure of FIG. 9 indicated by circle 11 showing the wires 14, 22 overlapping and welded 54. The wires 14, 22 can be welded every time they cross each other. The welding may be metallic welding if the wires are metallic, or may be bonded together using an adhesive or other means for attachment. Alternatively, the wires 14, 22 may be weaved together and bonded or attached every crossing or less frequently. FIG. 12 is an enlarged sectional view of the structure of FIG. 9 indicated by circle 12 showing the wires 14, 22 weaved 56 together. The weaving 56 can consist of placing one wire below another at one location and then above at another location. In this way the two wires 14 and 22 are woven and connected.

FIG. 10 is a top view of another exemplary embodiment of a wire mesh structure where two sets of parallel wires 14, 22 are combined at an angle relative to each other. The wires may form a diamond pattern, or a parallelogram shape. FIG. 13 is an enlarged sectional view of the structure of FIG. 10 indicated by circle 13 showing the wires 14, 22 welded and FIG. 14 is an enlarged sectional view of the structure of FIG. 10 indicated by circle 14 showing adjacent wires 14, 22 twisted and connected 58. FIGS. 11-14 also show the adhesive materials 82 on the wires 14, 22.

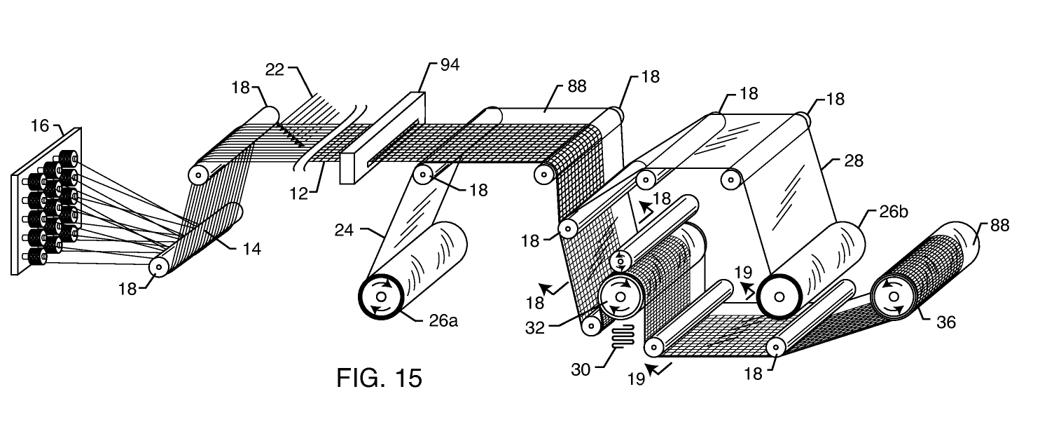

FIGS. 1 5-1 7 illustrate simplified perspective views of alternate embodiments of exemplary manufacturing processes already described above. FIG. 15 illustrates the wires 14 being fed from the creel 16 over idle rollers 18 and into the wefting and warping machine 20 where the perpendicular wires 22 are added. For clarity, the wefting and warping machine 20 is not illustrated in FIGS. 15-17, but is intended to be used as shown and described in FIG. 1. Subsequently the adhesive material 82 is applied by the device 80, 84 as shown and described in FIGS. 2A and 2B. For clarity, the application and curing processes are shown as box 94 in FIGS. 15-17. As illustrated previously in FIG. 3, laminate layers 24 and 28 are added to opposite sides of the wire grid 12 and heated by roller 32 before being rolled onto storage reel 36. Notably different from the earlier embodiments, a portion of the laminates 24, 28 extends beyond the width of the wire grid 12 so as to create an unobstructed area 88 that is devoid of the wire grid 12. The purpose for this will be explained in greater detail below.

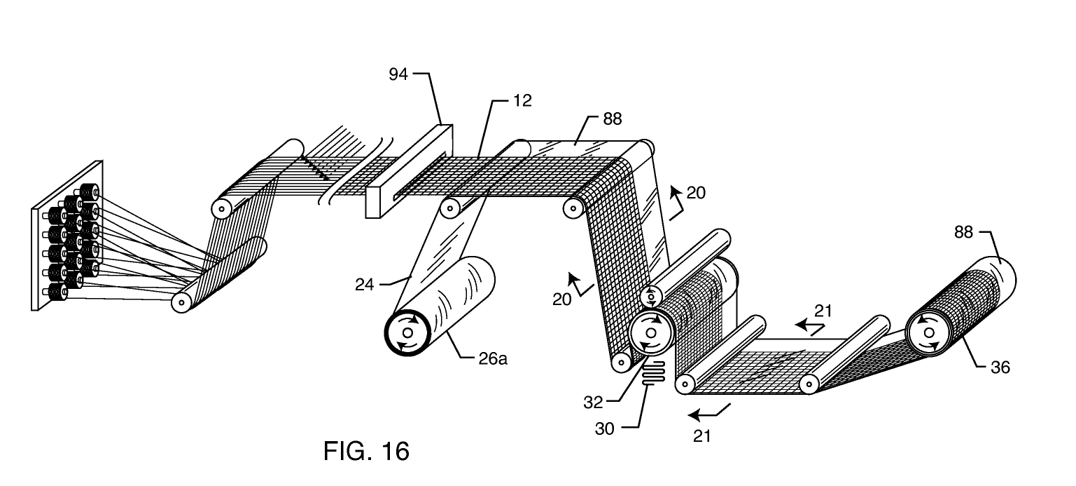

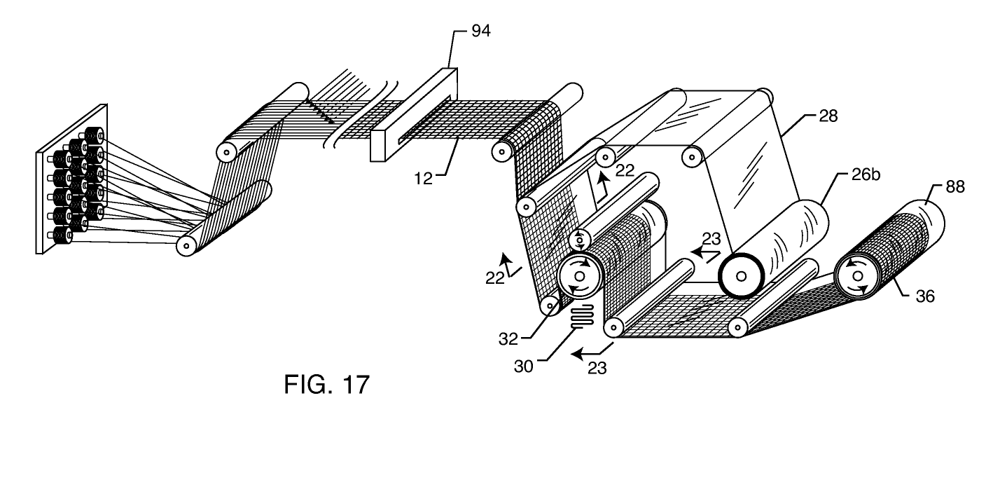

FIG. 16 illustrates a simplified perspective view of yet another alternate embodiment of an exemplary manufacturing process similar to FIG. 15. However, in FIG. 16 the wire grid 12 is attached to and bonded with a single laminate 24 as depicted. The second laminate 28 is omitted from this embodiment such that the wire grid 12 only has laminate 24 on the underside as depicted in this drawing. FIG. 17 illustrates a perspective view of yet another alternate embodiment of an exemplary manufacturing process similar to FIG. 16. However, in this embodiment the laminate 24 on the underside of the wire grid 12 is omitted and the laminate 28 on the upper side is included. This again results in a wire grid 12 having a laminate 28 only on its upper surface as depicted in the drawing.

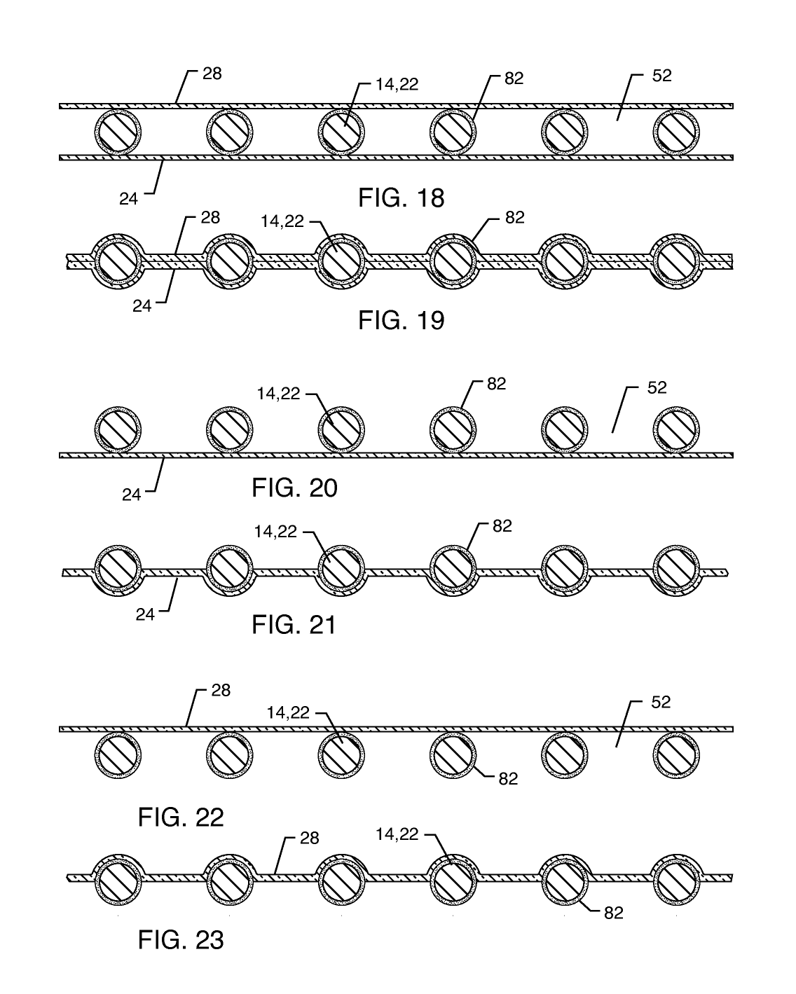

FIG. 18 is a side view of the structure manufactured in FIG. 15 taken along line 18-18. The first laminate 24 is on one side of the wire grid 12 and the second laminate 28 is on the other side of the wire grid 12. It can be seen in this stage that the two laminates 24 and 28 are not formed around the wire grid 12, but have void spaces 52 in between. FIG. 19 is a side view of the structure manufactured in FIG. 15 taken along line 19-19. Heat has been applied to form or mold both laminates 24 and 28 around the wire grid 12. The void spaces 52 have been eliminated.

FIGS. 20 and 22 illustrate side views of the structures manufactured in FIGS. 16 and 17 respectively taken along lines 20-20 and 22-22 therein. In FIG. 20, the first laminate 24 is on the underside of the wire grid 12 and the second laminate 28 is omitted. In FIG. 22, the second laminate 28 is on the top side of the wire grid 12 and the first laminate 24 is omitted. As in FIG. 18, the individual laminates 22 or 28 are not formed around the wire grid 12, but have void spaces 52 in between the wires 14, 22. FIGS. 21 and 23 are side views of the structure manufactured in FIGS. 16 and 17 respectively taken along lines 21-21 and 23-23 thereof. With heat having been applied to the single laminates 24 and 28, both respectively form or mold themselves to the wire grid 12. The void spaces 52 have been eliminated. Where only a single laminate is used in either of these illustrated embodiments, the wire grid 12 is exposed on the side of the laminate 24 or 28 that has been omitted.

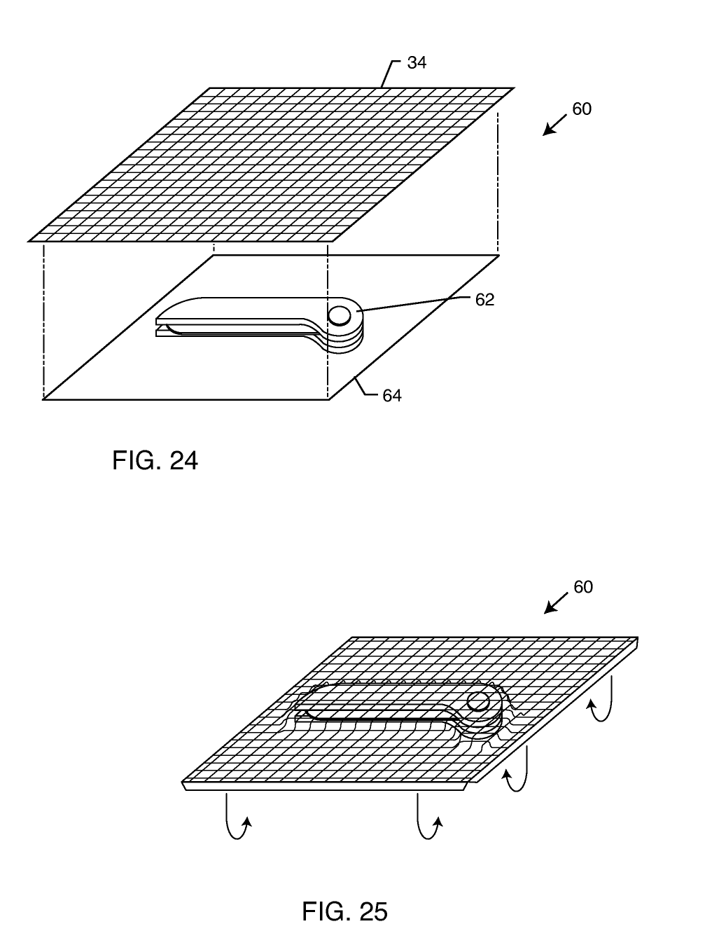

The theft proof product packaging material 34 can then be formed into a multitude of packing designs. FIG. 24 is a perspective view of a clam pack 60 embodying the present invention about to package a product 62. The product 62 is placed between a backing 64 and the packaging material 34. The backing 64 can be cardboard, wood, metal, plastic or any other appropriate material. FIG. 25 is a perspective view of the clam pack 60 of FIG. 24 now packaging the product 62. The material 34 has been pressed over the product 62 and the ends of the material folded over the backing 64. The ends may then be bonded or glued in place such that it cannot be easily opened.

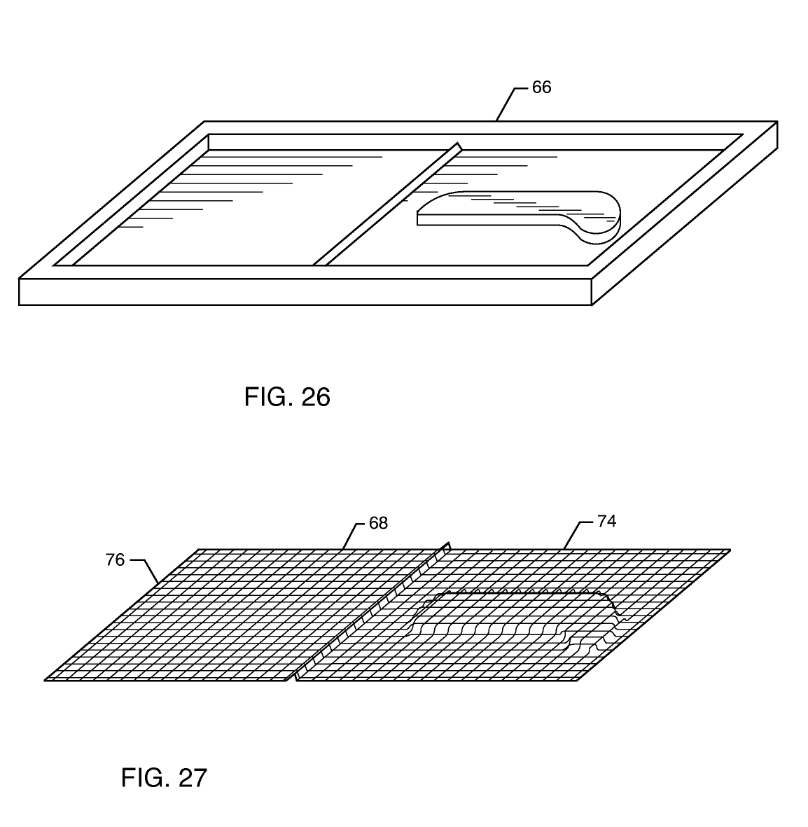

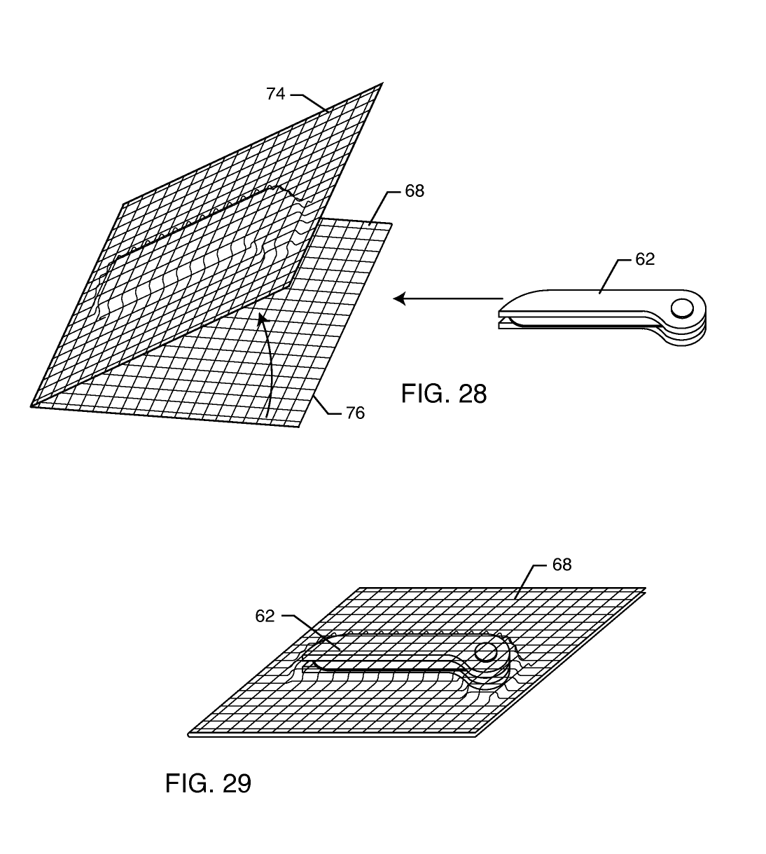

FIG. 26 is a perspective view of a clamshell mold 66 embodying the present invention. The clamshell mold 66 can be used to form the material 34 into a clamshell package 68. FIG. 27 is a perspective view of a clamshell package 68 before it is folded. The clamshell 68 has a front side 74 and a back side 76. Once the clamshell 68 has been formed, it can now package a product 62. FIG. 28 is a perspective view of the clamshell 68 of FIG. 27 now folded about to package a product 62. FIG. 29 is a perspective view of the clamshell 68 of FIG. 27 now packaging a product 62.

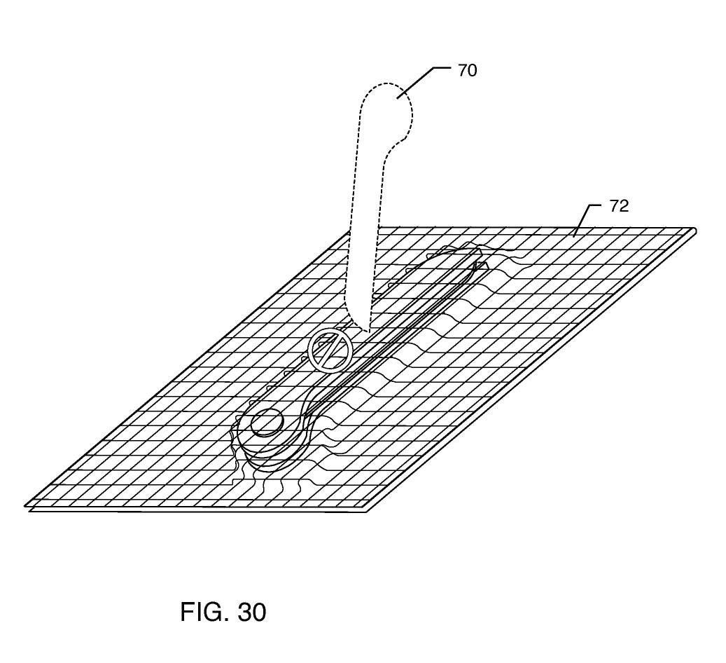

FIG. 30 is a perspective view of the structure of FIG. 29 now resistant to cutting with a knife or razor 70. The theft proof product package 72 securely contains the product 62. A razor 70 can easily cut the plastic, but it can't cut the wire grid/mesh 12. The plastic laminates 24 and 28 hold the wire grid/mesh 12 from being opened or moved aside. The wire grid 12 and plastic laminates 24 and 28 work together to create a tamper and theft resistance package. A thief can no longer easily open a package within a store to remove the product from the packaging. When the consumer buys the product, the consumer may use a pair of scissors to open the package. The scissors create a shearing action that is needed to cut through the wire mesh/grid 12. A knife or razor 70 cannot do this.

The cut-resistant wire-embedded plastic shell 72 allows the product to be seen underneath while presenting a visual deterrent to potential thieves. The theft proof product package 72 also would require a thief to spend a longer amount of time trying to remove the contents. Many thieves will be discouraged from theft due to the increased time it takes to steal a product.

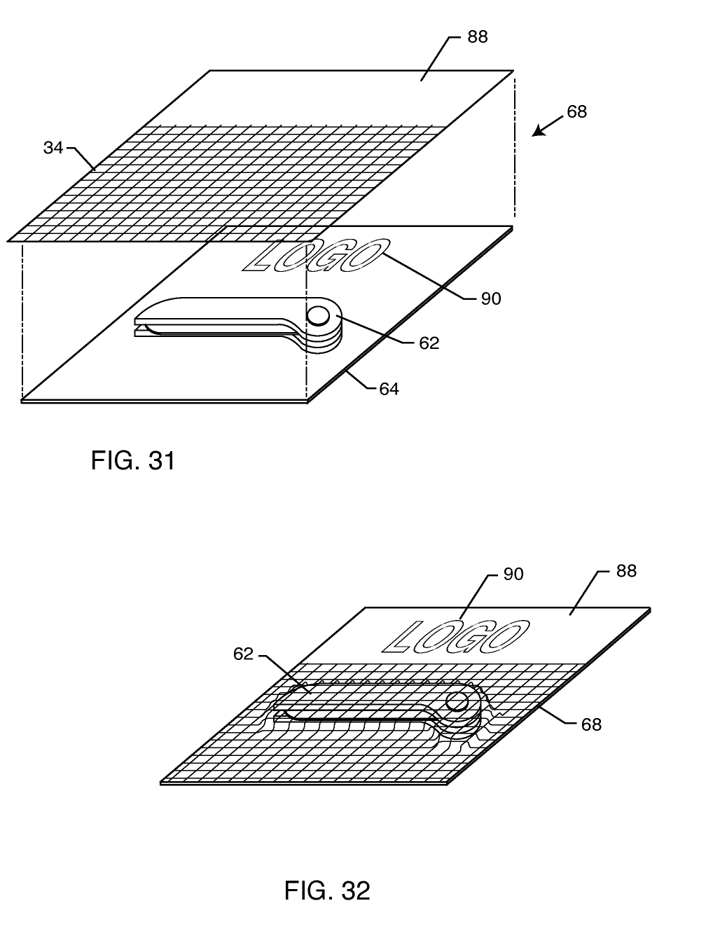

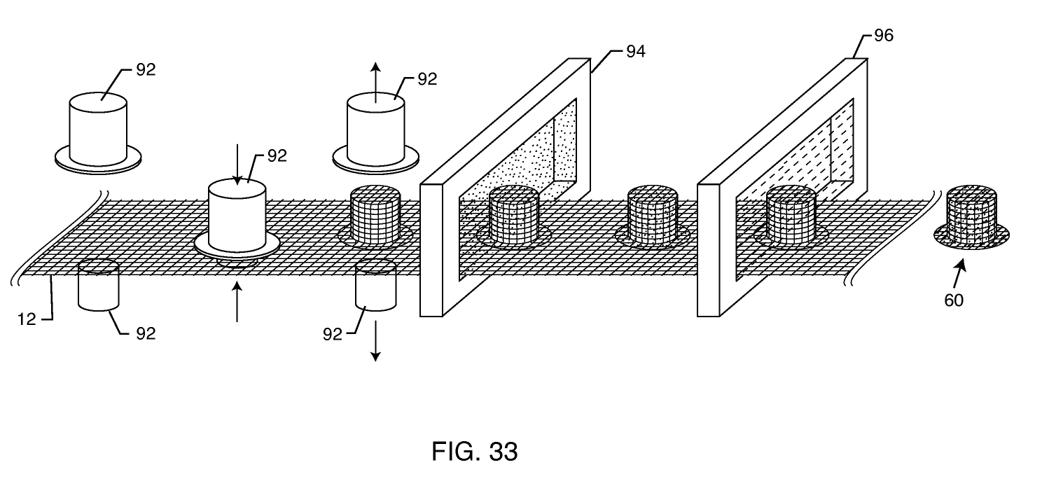

FIG. 31 illustrates an alternate embodiment of the clam pack depicted in FIGS. 24 and 25. In this embodiment, the theft-proof packaging material 34 including the unobstructed area 88 is used. In this way, the backing 64 can include trade identity information 90 such as a logo or other product identification which is not obstructed by the wire grid 12 or other theft-proof features of the packaging. FIG. 32 illustrates how the packaging material 34 including the unobstructed area 88 is attached to the backing 64 in such a way that the trade identity information 90 appears through the unobstructed area 88. The packaging material 34 and the backing material 64 are attached as described above in connection with FIG. 25.

The cut-resistant wire grid 12 can be formed from a multitude of materials including metals such as copper or steel, and also from cut resistant fabrics, such as Kevlar. Alternatively, the wire grid 12 can include a fabric core with a cut resistant coating such as a metallic or ceramic coating. As can be seen by one skilled in the art, various wires can be devised that are formable into a product package while being resistant to cutting with a knife or razor.

Because the wire mesh/grid 12 does the bulk of the work to stop a razor blade 70, the plastic laminates 24 and 28 or plastic feed 40 used can be thinner. This means there is less waste used in making plastic containers as less plastic is needed. Typically, a laminate of plastic is about 20 thousands of an inch thick. With the present invention, that thickness can be reduced to 6-10 thousands of an inch. For example, two laminates 24 and 28 at 6 thousands of an inch thickness would be a total thickness of 12 thousands. This is substantially thinner than the standard 20 thousands of an inch thickness used today.

FIG. 33 depicts a simplified perspective view of another exemplary manufacturing process of the present invention. The process depicted in FIG. 3 begins with a wire grid as is manufactured in FIG. 1 above. This wire grid is formed into one or more blister packs 60 through a machine process such as a tool and die 92. The tool and die 92 conforms the wire grid 12 to a particular shape configured to accept a product 62. After the tool and die process 92, the formed wire grid is passed through an adhesive machine 94 to apply and cure the adhesive material 82 to the wire grid as described above in connection with FIGS. 2A and 2B. The blister pack 60 then moves to a plasticizing process 96 that applies plastic or laminate material 24, 28 to the blister pack 60 using one of the methods described above, particularly those of FIGS. 3 and 4.

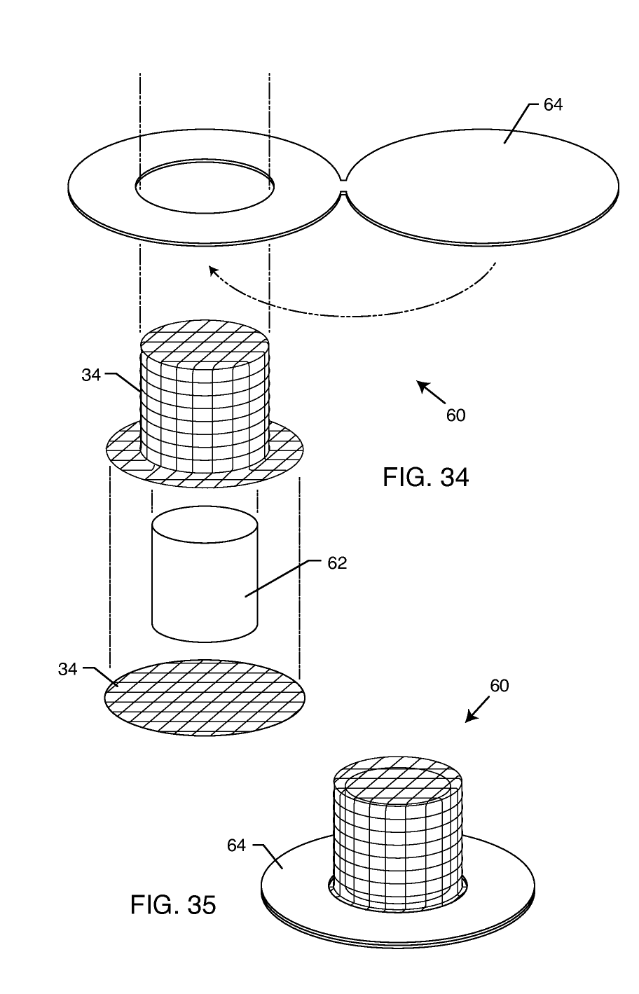

FIG. 34 is a perspective view of a blister pack 60 embodying the present invention about to package a product 62. The material 34 has been preformed to match the product 62. Alternatively, the product 62 may be packaged with filler such as cardboard or Styrofoam to conform to the blister pack 60. The backing 64 is formed to go around the material 34 and then fold over upon itself. The backing 64 is shown as one layer, but can be made from multiple layers of card stock or varying thicknesses and densities of cardboard. For instance, the backing 64 could be formed from two layers of card stock to give it sufficient stiffness and strength. The hole of the backing 64 contains one end of the material 34 and the backing 64 is then folded over one layer and adhered/sealed to itself. FIG. 35 is a perspective view of the blister pack of FIG. 34 now packaging a product.

The exemplary embodiments shown herein used two sets of wires 14 and 22 to form a wire grid 12. However, it is possible by one skilled in the art that only one set of wires 14 are required to form the theft proof product packaging material 34, as this disclosure is not necessarily limiting it to the required use of two wires 14 and 22. For example, one set of wires 14 may be utilized where the wires 14 are laid along a wavy (non-straight) pattern such that they essentially perform the function of a wire grid 12.

The theft proof product packaging material 34 can not only be used to make a blister pack and clamshell packages, but can be used to make other general packages such as boxes, tubes, shipping containers, envelopes and so forth. It is to be understood by one skilled in the art that the theft proof packaging material 34 can be used to a make a multitude of theft proof packages 72 beyond those specific embodiments shown and described herein.

Although several embodiments have been described in detail for purposes of illustration, various modifications may be made to each without departing from the scope and spirit of the invention. Accordingly, the invention is not to be limited, except as by the appended claims.

1. A method for manufacturing theft-resistant product packaging, comprising the steps of:
providing a matrix of cut-resistant strands;
adhering the matrix to a plastic substrate to form a theft-resistant material;
forming a front shell from the theft-resistant material including a cavity for holding a product therein; and
securing the front shell to a back cover so as to enclose the product therebetween.

2. The method of claim 1, wherein the providing step comprises the steps of orienting a first set of individual strands in a first direction, orienting a second set of individual strands in a second direction different from the first direction, and forming the matrix by overlaying, weaving, wefting and warping, or twisting the first and second sets of strands together.

3. The method of claim 2, further comprising the step of securing, welding, gluing or bonding the first and second sets of wires together.

4. The method of claim 2, wherein the first and second directions are oriented perpendicularly.

5. The method of any of claims 1-4, further comprising the step of coating the strands with a hard, outer shell comprising a hardened adhesive, a powdered metal, or a ceramic material.

6. The method of any of claims 1-4, wherein the adhering step comprises the steps of applying a first laminate of thermoplastic or bio-film material to one side of the matrix, and heating the matrix and first laminate such that the first laminate softens.

7. The method of claim 6, wherein the applying step comprises the steps of applying a first laminate of thermoplastic or bio-film material to one side of the matrix, and applying a second laminate of thermoplastic or bio-film material to another side of the matrix.

8. The method of claim 6, further comprising the step of pressing the heated matrix and first laminate such that the first laminate becomes formed around and bonded to the matrix.

9. The method of claim 6, further comprising the step of cooling the matrix and first laminate to fix the matrix and first laminate together.

10. The method of any of claims 1-4, wherein the adhering step comprises the steps of pulling the matrix across a surface, dispensing small pieces of thermoplastic or bio-film material over the matrix on the surface, heating the small pieces such that they melt around the matrix, and rolling the matrix and heated small pieces such that they form the plastic substrate around the matrix.

11. The method of claim 10, further comprising the step of cooling the matrix and plastic substrate to fix the matrix and plastic substrate together.

12. The method of any of claims 1-4, wherein the forming step comprises the steps of shaping the theft-resistant material into a clam shell or blister pack, and preforming a recess in the front shell conformed to a shape of the product.

13. The method of any of claims 1-4, wherein the forming step comprises the step of forming an unobstructed area in the front shell that is devoid of the matrix.

14. The method of any of claims 1-4, wherein the back cover comprises cardboard, wood, metal, plastic or theft-resistant material.

15. The method of any of claims 1-4, wherein the securing step comprises folding, bonding, gluing and/or stapling edges of the front shell and back cover together.
